(19) United States
(12) Patent Application Publication
(10) Pub. No.: US 2011/0038663 A1
(43) Pub. Date: Feb. 17, 2011

(54) METHOD OF ATTACHING TWO LARGE STRUCTURAL MEMBERS

(75) Inventor: Richard L. Nicoson, Hartford, WI (US)

Correspondence Address: JAMES EARL LOWE, JR., 15417 W NATIONAL AVE # 300, NEW BERLIN, WI, 53151, US

(73) Assignee: HARNISCHFEGER TECHNOLOGIES, INC., Wilmington, DE (US)

(21) Appl. No.: 12/542,181

(22) Filed: Aug. 17, 2009

(51) Int. Cl. F16B 1/00

(52) U.S. Cl. 403/24

(57) ABSTRACT

A method of attaching a first structural member to a second structural member, the method comprising the steps of: attaching a plurality of spaced apart female pieces to the first structural member, pivotally attaching a plurality of spaced apart male pieces to the second structural member, the positions of the male pieces corresponding to the positions of the female pieces, inserting the male pieces into the female pieces, and connecting the male pieces and respective female pieces together.

### BACKGROUND

This disclosure relates to a method of attaching two large structural members together, and more particularly, to a method of attaching a ladder to the boom of an electric shovel.

Currently, as shown in FIGS. 1 and 2, the large structural members are positioned adjacent each other, and an L-shaped piece of metal 2 is positioned at the contact point between the two structural members 4 and 6. Welding of the piece of metal to the structural members then serves to attach the two structural members. As one can imagine, with each welding of each piece of metal, the careful positioning of the two structural members adjacent each other can be altered. As a result, the careful positioning of the structural members is often compromised.

### SUMMARY

The object of this invention is to facilitate the attachment of large structural members.

This disclosure provides a method of attaching a first structural member to a second structural member, the method comprising the steps of: attaching a plurality of spaced apart female pieces to the first structural member, pivotally attaching a plurality of spaced apart male pieces to the second structural member, the positions of the male pieces corresponding to the positions of the female pieces, inserting the male pieces into the female pieces, and connecting the male pieces and respective female pieces together.

In the preferred embodiment, the method includes providing space between the connecting rod and the male piece to permit some vibration freedom between the structural members, and providing a rubber bushing between the connecting rod and the male piece to permit some vibration freedom between the structural members.

### BRIEF DESCRIPTION OF THE DRAWINGS

FIG. 1 is a perspective view of two large structural members attached one to another. More particularly, FIG. 1 illustrates a ladder attached to a boom of an electric shovel.

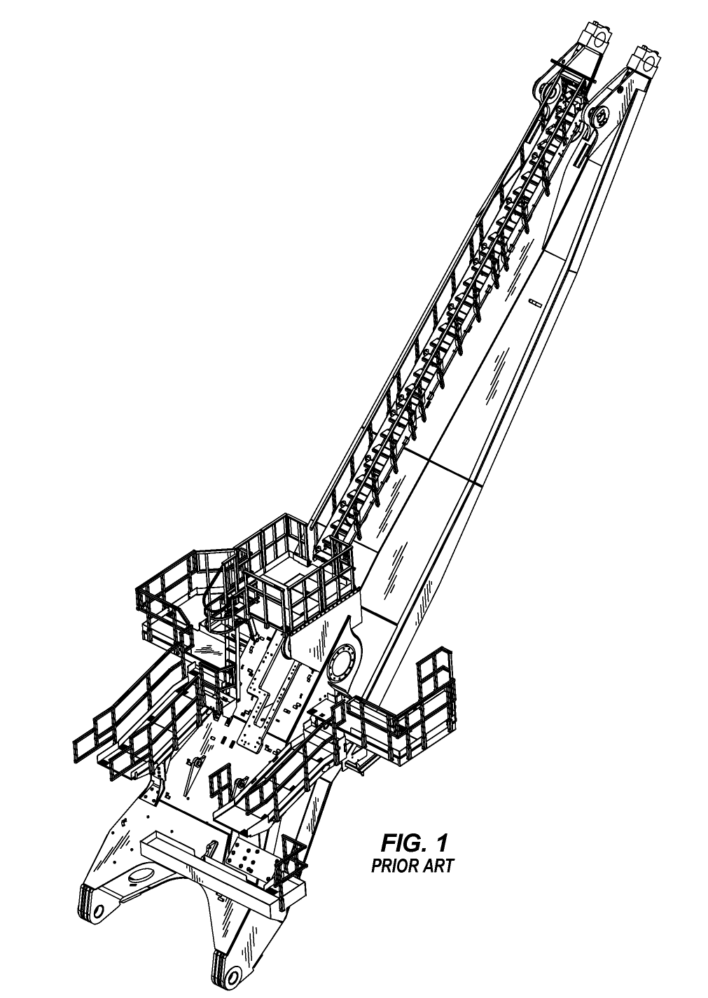

FIG. 2 is a perspective view of the place of attachment of the ladder to the boom, illustrating an L-shaped metal piece.

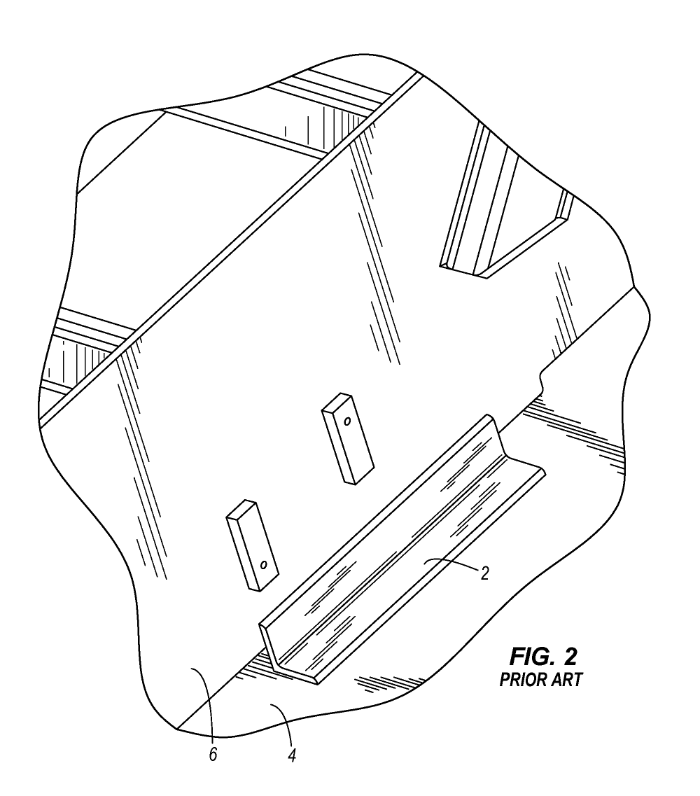

FIG. 3 is a perspective view of the attachment of the latter to the boom using the joint of this disclosure.

FIG. 4 is a perspective view of a cross-section of the joint shown in FIG. 3.

FIG. 5 is a perspective view of a ladder attached to a boom of an electric shovel using the joint of this disclosure.

Before one embodiment of the disclosure is explained in detail, it is to be understood that the disclosure is not limited in its application to the details of the construction and the arrangements of components set forth in the following description or illustrated in the drawings. The disclosure is capable of other embodiments and of being practiced or being carried out in various ways. Also, it is to be understood that the phraseology and terminology used herein is for the purpose of description and should not be regarded as limiting. Use of “including” and “comprising” and variations thereof as used herein is meant to encompass the items listed thereafter and equivalents thereof as well as additional items. Use of “consisting of” and variations thereof as used herein is meant to encompass only the items listed thereafter and equivalents thereof. Further, it is to be understood that such terms as “forward”, “rearward”, “left”, “right”, “upward” and “downward”, etc., are words of convenience and are not to be construed as limiting terms.

### DESCRIPTION OF THE PREFERRED EMBODIMENT

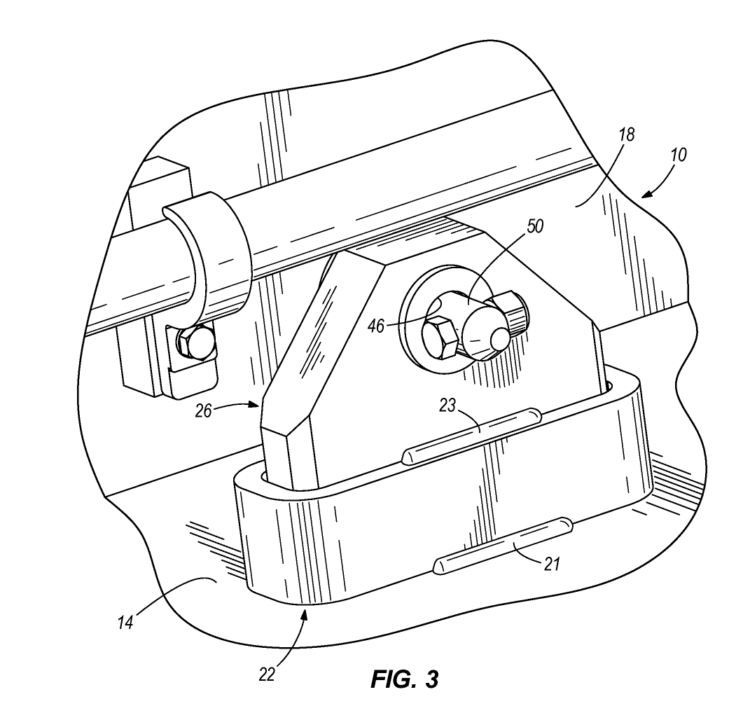

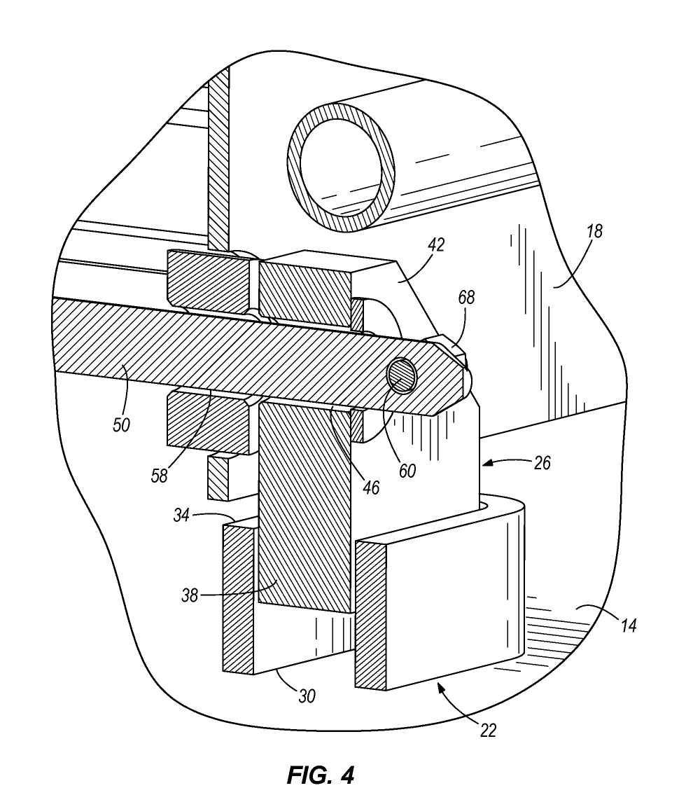

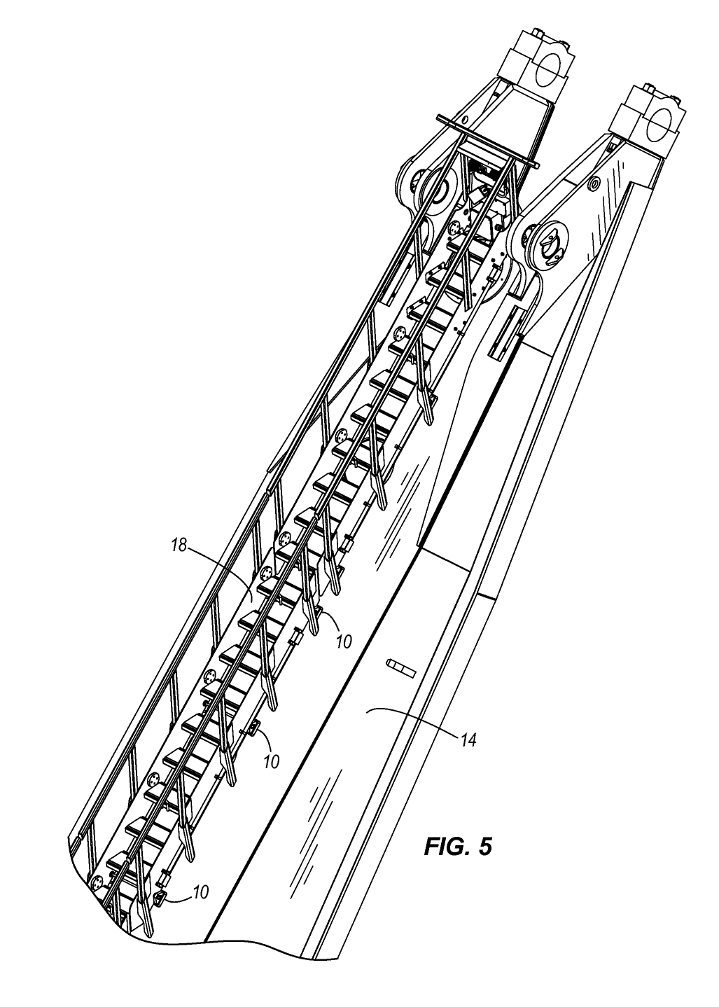

As illustrated in FIGS. 3 through 5, this disclosure provides a method of attaching a first large structural member to a second large structural member, where the first large structural member is a boom 14 of an electric shovel (not shown), and wherein the second large structural member is a ladder 18 for servicing the boom 14. The method comprises the steps of forming a point of attachment 10 between the boom 14 and ladder 18 by attaching, such as by welding 21, a plurality of spaced apart female pieces 22 to the first structural member 14, pivotally attaching a plurality of spaced apart male pieces 26 to the second structural member 18, the positions of the male pieces 26 corresponding to the positions of the female pieces 22, inserting the male pieces 26 into the female pieces 22, and connecting, such as by welding 23, the male pieces 26 and respective female pieces 22 together.

More particularly, the female piece 22 is a metal oblong cylinder, having an open bottom 30 and an open top 34. The male piece 26 is a metal plate sized in order to fit securely within the female piece 22. The male piece 26 has rounded corners to facilitate its insertion into the female piece 22.

The male piece 26 is a plate having a first square end 38, and a second opposite tapered end 42. The tapered end 42 has an opening 46 adapted to receive a connecting rod 50. The connecting rod 50 extends through the ladder 18 and through the opening 46 in the male piece 26. In the preferred embodiment, not shown, the connecting rod passes through spaced apart openings 58 in the ladder 18, and a male piece 26 is received on the end of the connecting rod 50 on the outside of each of the opposite sides of the ladder 18.

After the connecting rod 50 passes through the opening 46 in the male piece 26, a bolt 60 passes through an opening 64 in the end of the connecting rod 50, and a nut 68 is placed on the end of the bolt 60. In the preferred embodiment, the rod 50 is loosely received within the opening 46 in the male piece 26 to help prevent transmission of ladder vibrations to the boom 14. A steel or rubber bushing (not shown) can also be provided between the connecting rod 50 and the male piece 26 to permit some vibration freedom between the structural members.

Various other features and advantages of the disclosure are apparent from the following claims.

1. A method of attaching a first large structural member to a second large structural member, the method comprising the steps of:
attaching a plurality of spaced apart female pieces to the first structural member,
pivotally attaching a plurality of spaced apart male pieces to the second structural member, the positions of the male pieces corresponding to the positions of the female pieces,
inserting the male pieces into the female pieces, and
connecting the male pieces and respective female pieces together.

2. A method in accordance with claim 1 and further including the step of providing space between the connecting rod and the male piece to permit some vibration freedom between the structural members.

3. A method in accordance with claim 2 and further including the step of providing a rubber bushing between the connecting rod and the male piece to permit some vibration freedom between the structural members.

4. A method in accordance with claim 2 wherein the first large structural member is the boom of an electric shovel, and wherein the second large structural member is ladder for servicing the boom.
